(19) United States
(12) Patent Application Publication
(10) Pub. No.: US 2014/0379448 A1
(43) Pub. Date: Dec. 25, 2014

(54) Method For Purchasing Regulated Products Via The Internet

(71) Applicant: Robert Gregory, Oyster Bay, NY (US)

(72) Inventor: Robert Gregory, Oyster Bay, NY (US)

(21) Appl. No.: 14/312,169

(22) Filed: Jun. 23, 2014

Related U.S. Application Data
(60) Provisional application No. 61/838,489, filed on Jun. 24, 2013.

(51) Int. Cl. G06Q 30/06; G06Q 20/12; G06Q 30/02; G06Q 10/08

(52) U.S. Cl. CPC G06Q 30/0619; G06Q 10/087; G06Q 10/0838; G06Q 20/12; G06Q 30/0215; G06Q 30/0226
USPC 705/14.17; 705/26.44

(57) ABSTRACT

The present invention relates to an order management system for purchasing regulated products such as wine over the Internet. Currently, U.S. states require wine to be purchased directly from a licensed retailer or a producer permitted to ship the wine directly to the consumer. In a computer system, the present invention relates to methods for managing orders between a consumer and a wine producer or licensed retailer wherein the transaction is facilitated via a third party website, such as a wine club website. The methods of the present invention may also facilitate allocation of payments to a charity as part of the transaction, and for the use of split tender payments using virtual currency.

### CROSS-REFERENCE TO RELATED APPLICATIONS

This application claims the benefit of U.S. Provisional Application No. 61/838,489, entitled, “Method for Purchasing Regulated Products Via the Internet,” by Robert Gregory. The entire teachings of that application are incorporated herein by reference.

### STATEMENT REGARDING FEDERALLY SPONSORED RESEARCH OR DEVELOPMENT

Not Applicable

### REFERENCE TO SEQUENCE LISTING, TABLE, OR COMPUTER PROGRAM LISTING

Not Applicable

### BACKGROUND OF THE INVENTION

Currently, the United States is the largest wine market in the world, with an estimated retail value of $34.6 billion. It is expected that American wine consumption will continue to expand over the next decade as wine becomes more popular with adult consumers. Indeed, the U.S. wine market has experienced almost two decades of volume growth.

One reason for growth in the U.S. wine market is that consumers simply have more access to wine. In particular, the availability to purchase products via the Internet has increased consumer access to wine, including access to many wines not available at a consumer's local brick and mortar store.

Further, potential consumers of wine may seek to educate themselves about different aspects of wine via the Internet. For example, a consumer may wish to learn about different grape varietals. In addition, wine consumers may also base purchases of wine on recommendations found on the Internet and social media outlets, or may seek out Internet groups having members sharing a similar interest in wine, or for discussing wine. Consumers may also use the Internet to find out the retail or best available price of a wine, so as not to overpay.

An Internet website such as a wine club website that provides wine education to its members, mechanisms for posting and receiving reviews of wine, as well as opportunities to earn virtual rewards that can be applied to reduce the cost of a wine among other things would be appealing to many wine consumers. For example, a consumer may become educated about a particular wine through the wine club website, or may read reviews of a wine on the wine club website, and may wish to purchase that wine through the wine club website.

However, the sale of alcoholic beverages such as wine is regulated via individual states under a so-called “three-tier” system. The three-tier system of alcohol distribution is the system for distributing alcoholic beverages set up in the United States after the repeal of Prohibition. The three tiers are: (1) producers, (2) distributors, and (3) retailers. The basic structure of the system is that producers can sell their products only to wholesale distributors who then sell to retailers, and only retailers may sell to consumers. Producers include brewers, wine makers, distillers and importers.

An example of a state that follows the three-tier system is the State of New York. In New York, the purchase and sale of alcoholic beverages such as wine is governed by the State Liquor Authority (9 NYCRR subtitle B) and the Alcoholic Beverage Control Law (“ABCL”). ABCL §100(1) requires any person engaged in the manufacture for sale or sale (at wholesale or retail) of alcoholic beverages to obtain the appropriate license from the Authority. ABCL §111 prohibits a licensee from making its license available to a person who has not been approved by the Authority to hold that license.

While states such as New York only permit licensed retailers to sell wine to consumers, some states have adopted laws or regulations whereby certain wineries, such as in-state wineries, can obtain licenses or permits to ship their product directly to consumers.

Accordingly, under the current system, a consumer must either purchase a wine product directly from a licensed retailer or a producer that can ship the wine directly to the consumer. For example, the consumer must visit a licensed retailer's brick and mortar location to make a desired wine purchase.

Thus, a need exists for an order management system that allows consumers, such as wine club members, to order wine via the Internet website of a third party, such as a wine club website, wherein the purchase is transacted between the consumer and either a licensed retailer or producer that is allowed to direct ship the wine to the consumer.

### BRIEF SUMMARY OF THE INVENTION

The present invention relates to methods for purchasing regulated products, such as wine, over the Internet. In particular, in a computer system, the present invention relates to methods for managing orders to purchase wine between a consumer and a retailer that is licensed to sell the wine to the consumer or a producer that is permitted to ship the wine directly to the consumer, wherein the order is placed via a third party website such as a wine club website. Currently, in order for a consumer to purchase wine over the Internet and have it shipped to an address in a particular state, the purchase must comply with the laws and regulations governing the sale of alcohol in that state. Most if not all states require alcohol such as wine to be purchased by a consumer from a licensed retailer, or, in some cases, a producer may be permitted to ship the wine directly to the consumer. Thus, a consumer cannot purchase wine directly from a third party, such as through a wine club's website, thereby inconveniencing the consumer. For example, a consumer who is a member of a wine club website may learn about a particular wine on the website, either by reading about different wines or through a review posted by another member. The consumer may then wish to purchase the wine using the wine club's website. However, because of the three-tier system, the consumer must separately identify a retailer or producer that is able to complete the purchase, either via another website or at a brick and mortar store. Alternatively, the consumer may not even be able to find the desired wine for sale, for example, if the consumer's local retail stores do not carry the desired wine product.

The methods of the present invention solve this problem by effecting a consumer's order for the purchase of wine via a third party website, such as a wine club, wherein the transaction is completed between the consumer and the wine producer or a retailer, such that the purchase complies with the relevant state's laws and regulations for purchasing alcoholic beverages. In an exemplary embodiment, the method of the present invention comprises the steps of receiving an order from a consumer for the purchase of at least one bottle of wine, the order comprising at least one data field indicating the producer of the wine; receiving a shipping address associated with the order, the shipping address comprising at least one data field indicating a U.S. state; determining that the order qualifies for direct shipment by the producer; determining the cost of the order; identifying the producer's merchant account for conducting financial transactions over a payment network; establishing a financial transaction between the producer and the consumer for the cost of the order; initiating a payment process directed to the transaction; completing the transaction, wherein the producer's merchant account receives payment for the cost of the order; and providing a display indicating completion of the transaction.

In an alternative embodiment, it is determined that the producer is not permitted to direct ship the desired wine product to the consumer. In this case, the method of the present invention includes the steps of identifying one or more retailers that can complete the order; selecting a retailer to complete the order; determining the cost of the order; determining the retailer's merchant account for conducting financial transactions over a payment network; and completing the transaction between the consumer and the selected retailer. If more than one retailer is identified that can complete the order, then the retailer that voluntarily offers to complete the order most cost effectively is selected.

The methods of the present order management system further relate to allowing the consumer to use virtual currency to pay for all or part of the cost of the order. For example, the consumer may be a member of a wine club website that offers rewards, in the form of virtual currency, to its members for completing certain acts, such as posting a review of a wine. In a computer system, the methods of the present invention may comprise receiving, as part of the consumer's order, at least one data field indicating the consumer's identification; determining the consumer's amount of virtual currency by querying a database, stored on one or more computers, that contains at least one data field indicating the consumer's virtual currency amount based on the consumer's identification; calculating the equivalent amount of the virtual currency to be applied to the cost of the order in U.S. dollars; and subtracting the equivalent U.S. dollar amount from the cost of the order to arrive at a new cost of the order.

In addition, the order management system of the present invention relates to allocating all or part of the cost of the order to a charitable organization. In one embodiment, the methods of the present invention include the steps of determining that at least a portion of the cost of the order is a donation by the retailer or producer to a charitable organization; and transferring the donated amount to the charitable organization. As part of the present order management system, consumers may be awarded virtual currency to encourage purchases that result in a charitable donation.

There are a number of advantages associated with the present order management system. The methods of the present invention greatly increase consumer ease in purchasing wine by allowing a consumer visiting a single website, such as a third-party wine club website, access to wine through that website wherein the transaction is effected either between a licensed retailer or a producer that can direct ship the wine to the consumer, thereby preventing the consumer from having to visit another website or brick and mortar store to purchase the wine product. Moreover, the order management system of the present invention further relates to the use of virtual currency to pay for at least part of the cost of the order, such that the cost of the order is split between the virtual currency and an internationally recognized currency such as U.S. dollars. The split tender aspects of the present invention provide the added benefit of allowing a producer or retailer to discretely allocate gross margins toward customer acquisition programs such as cause related affinity marketing programs that benefit both the producer and retailer. The present invention also manages the consumer's order such that all or part of the purchase may result in a charitable donation, thus facilitating ease of charitable donations.

The present invention includes any combination of the embodiments described herein.

### BRIEF DESCRIPTION OF THE DRAWINGS

FIG. 1 is a schematic of a flow chart showing an embodiment of the present invention.

FIG. 1A is a schematic of a flow chart showing an alternative embodiment of the present invention.

### DETAILED DESCRIPTION OF THE INVENTION

The present invention is directed to methods, in a computer system, for managing orders for the purchase of wine wherein a consumer purchases wine via a third party website, such as a wine club website, and the transaction is completed between the consumer and either a licensed retailer or producer that can direct ship the wine to the consumer. As used herein, the term “third party website” means a website that is neither owned nor maintained by the producer or retailer that takes part in the transaction with the consumer.

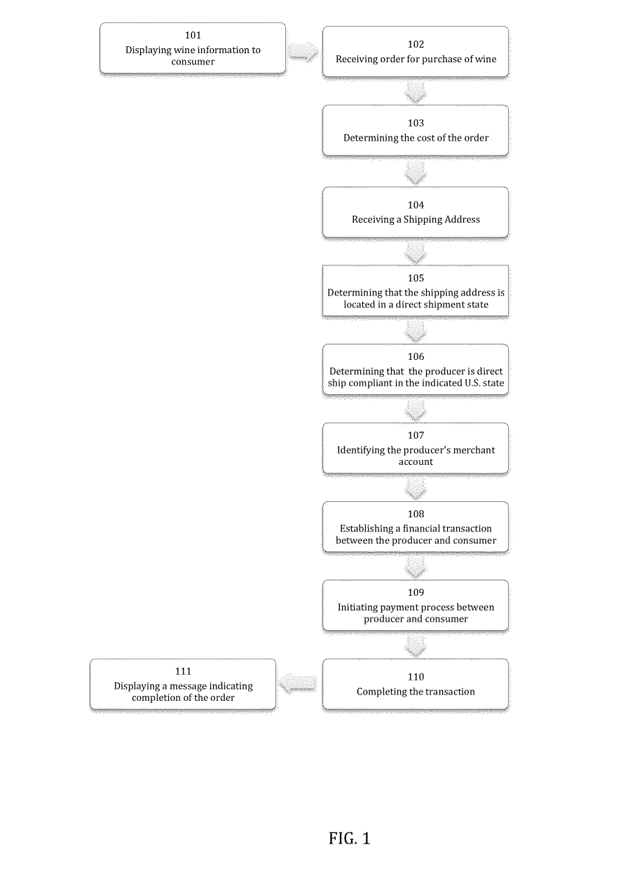

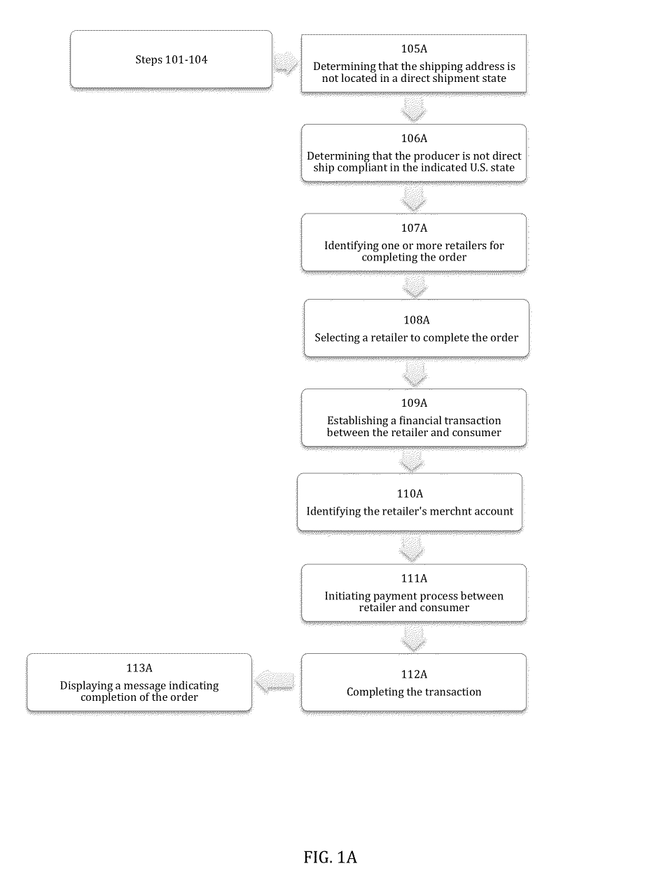

An exemplary embodiment of the methods of the present invention is described with reference to FIG. 1 hereto. As shown in FIG. 1, information regarding a wine product is displayed to a consumer (101). For example, wines made from a particular grape varietal, e.g., Malbec, or producer, e.g., Ravenswood Winery, may be displayed. As used herein, the term “consumer” means any individual or entity that places an order to purchase wine. For example, the consumer may be a member of the general public, or a member of a wine club, wherein access to content on the wine club's website is restricted to the website's members that set up a user account with the website and the website's content is accessed by entering in user account information. Further, as used herein, the term “producer” means a person or entity engaged in making (producing) the wine product, such as a winery.

Consumers may learn about a wine product by any means, e.g., the newspaper or social media content. On the wine club website, for example, consumers may investigate or be educated about certain wine topics such as grape varietals, e.g., Pinot Noir, or wine producing territories, e.g., Western Coast of Sonoma. The website may then display, either automatically or at the request of the consumer, wine for sale containing a particular grape, or wine from a particular producer or territory. The consumer may then select a wine for purchase from the website. For example, the consumer may choose to purchase one bottle to multiple cases of Stag's Leap Cabernet Sauvignon Napa Valley.

While the consumer may purchase multiple bottles of the same wine, the consumer may or may not be able to purchase different wines via the same transaction. If the consumer wishes to purchase, for example, wines from the same territory but from different wineries/producers, the consumer may have to complete a separate transaction for each particular wine or producer.

After the consumer selects a wine for purchase, the consumer places his or her order via a computer terminal. In one embodiment, the method of the present invention includes the step of receiving the consumer's order (102). For example, the consumer may place an order using the wine club website's online shopping cart. The order for the wine contains at least an indication of the producer of the wine.

The method of the present invention includes receiving a shipping address (104). As used herein, the term “shipping address” means the address to which the order will be delivered and includes at least a U.S. state indication. For example, the customer may enter a shipping address by typing the shipping address into the data fields specified for entering in the shipping address in website's shopping cart.

In an embodiment, placing the order requires the consumer to enter in/submit a valid U.S. postal delivery address for the shipping address. As used herein, the term “valid U.S. postal delivery address” means an address in the United States to which the U.S. Post Office or a third party shipping company such as Federal Express can deliver mail, packages and/or shipments.

In an alternative embodiment, the shipping address may be pre-stored in a database located on one or more computer servers. As used herein, the term “database” means a collection of data or information organized for search and retrieval, especially by a computer.

For example, the shipping address may be pre-stored as part of the consumer's profile on the wine club website. The consumer may be a member of a wine club website, wherein the consumer, as part of setting up a user account with the website, entered in a shipping address associated with the consumer's user account or user profile, which contains one or more data fields, such as the consumer's name, for identifying the consumer. When the consumer places an order, the pre-stored shipping address may be retrieved by querying a database, stored on one or more computer servers, associating the consumer's identification with the shipping address.

The method of the present invention may further comprise the steps of determining if the order qualifies for direct shipment by the producer (105-106). As used herein, the term “direct shipment” means that the wine may be purchased by the consumer directly from the producer (or the producer's agent), and shipped directly from the producer (or the producer's agent) to the consumer's shipping address. For example, an order that qualifies for direct shipment may be transacted directly between the consumer and the producer, as opposed to between the consumer and a licensed retailer.

In one embodiment for determining if the order qualifies for direct shipment by the producer, a database is queried to determine if the shipping address is located in a U.S. state that allows for direct shipment (105). Alternatively, the shipping address may be queried against a preexisting list of direct ship states. In another example, before entering the shipping address, or during, or after, the consumer may be able to view a list of states that allow direct shipment, such as a list of states on a drop down menu, or may be able to query a list of states that allow direct shipment, or may be able to query whether a particular state allows direct shipment. In this way the consumer may choose to enter a shipping address for the order that the consumer already knows is located in a state that permits direct shipment from the producer.

Further, if direct shipment of the wine from the producer to the shipping address is allowed, then a query is performed to determine if the producer is direct ship compliant in the indicated U.S. state (106). As used herein, the term “direct ship compliant” means that the producer is licensed to direct ship in the state to which the wine will be shipped, or that the producer has submitted the appropriate filings to direct ship to that state. As part of the present invention, it is contemplated that steps 105 or 106 may be eliminated if redundant, or may be combined all or in part.

If it is determined that direct shipment is permitted, then the present order management system includes identifying the producer's merchant account for completing payment of the purchase (107). This may be done, for example, by querying a database associating the producer with information regarding the producer's merchant account, said producer's merchant account being an account associated with a payment processor or gateway system associated with the present order management system.

The merchant account details may include, for example and without limitation, the merchant name, merchant phone number and address, merchant number, store number, terminal ID and number, merchant category code, location code, and/or any other information required by a particular payment processor, gateway or servicing system for executing the transaction with the merchant account.

After determining the producer's merchant account, the transaction is executed between the consumer and the producer for the cost of the order (108-109). Although the consumer is completing the payment portion of the transaction using the payment gateway of a third party (e.g., wine club) website, the transaction is effected between the producer and the consumer such that the producer's account charges the consumer for the purchase, and the producer receives payment for the purchase. On the consumer's credit card statement, for example, the purchase will be identified as a charge from the producer.

The method of the present invention may further comprise the step of determining the cost of the order (103). For example, the cost of the order may include the retail cost of the wine, the cost of shipping, taxes, and/or any fees associated with the order. In one embodiment, where the transaction is completed between the consumer and the producer, the consumer may be charged by the producer's account not only for the wine purchase but also for the cost of shipping and any applicable taxes and/or fees.

If shipping fees are included as part of the cost of the order, then the producer pays the shipper directly for the shipment costs. Payment of the shipping fees may be effected individually by the producer, or the order management system of the present invention may effect payment on behalf of the producer. For example, the order management system of the present invention may transfer the amount of the shipping costs from the merchant account of the producer to the shipping company. The third party website may or may not have an agreement with a shipper for volume discounted shipping fees which may be passed on to the consumer by the producer. For example, the third party may have an agreement such that it receives reduced Federal Express shipping rates. The producer may then have its own Federal Express account number that allows it to take advantage of the discounted shipping rates of the third party, and these discounts are passed along to the consumer. The wine is then shipped from the producer or an offsite location using the appropriate shipping vendor. The consumer then receives the wine at the specified shipping address.

FIG. 1A depicts an alternative embodiment of the order management system of the present invention in which it is determined that the consumer's order does not qualify for direct shipment from the producer. For example, the method of the present invention determines that the shipping address is not located in a U.S. state that allows for direct shipment of wine from the producer (105A), or determines that the producer is not direct ship compliant in the indicated U.S. state (106A), or both. Such determination(s) may be made by querying one or more databases containing an indication(s) that the order does not qualify for direct shipment.

If it is determined that the order does not qualify for direct shipment, then one or more retailers that can complete the consumer's order are identified (107A). Retailers are provided open access to compete for new customers in their state. A database may be queried as to whether there are any retailers that are: (1) capable of shipping to the desired address, e.g., that are located directly in the ship to state or that are located in a state that has reciprocity with the ship to state, and/or (2) appropriately licensed to complete the transaction with the consumer. Alternatively, these steps may be reversed, or combined, or one of these queries may be eliminated if redundant or unnecessary.

A retailer is then selected to complete the order (108A). If a single retailer is identified that can complete the order, then that retailer is selected to complete the order. If more than one retailer is identified that can complete the order, then the retailer that can complete the order most cost effectively is selected to complete the transaction. For example, the retailer may have already provided to the third party, e.g., wine club website, the minimum mark up it requires for a particular wine, or the retailer may be queried for the lowest price it will accept, thus allowing the retailer to set the sales price. Alternatively, if the retailer has not agreed on the price it will accept for a particular bottle or volume of bottles, then prior to completing the transaction the retailer may be queried as to whether it will agree to complete the transaction at a certain price. In an alternative embodiment, as part of the method of the present invention the retailer may agree to complete the transaction at a certain price by selecting “yes” from a drop down or slide menu presented by the present method. Alternatively, the retailer may decline to complete the transaction in response to a query. In an additional embodiment, the retailer may be able to propose a new sales price or an alternative selection in response to a query.

Once a retailer for completing the transaction is identified, then that retailer's merchant account details are determined (110A). The method of the present invention then executes the payment transaction between the retailer and the consumer with the retailer's merchant account information (111A-112A). In an embodiment, the transaction is completed between the retailer and the consumer, and the retailer's merchant account receives payment for the cost of the order.

The transaction may be executed such that the consumer's receipt or credit card bill entry shows the producer's name instead of the retailer's name. The purpose of this is to make it easy for the consumer to identify the transaction, since the consumer will not know the name of the retail shop fulfilling the transaction, and to prevent consumer confusion, which may cause unnecessary charge backs. The retailer may be identified on the packing slip of the shipment and/or, if the consumer is a member of the wine club website, through the member's user account information.

Alternatively, the website and/or consumer's credit card statement may identify the retailer, producer, and/or wine being purchased. Upon completing the order, the method of the present invention may comprise displaying a message indicating completion of the order to the consumer (113A). After the retailer receives payment, the retailer may, at its option, choose not to fulfill an order, for example due to lack of inventory. In such a case, the consumer would receive a refund for the payment amount.

As part of the present invention, the consumer may be charged by the retailer's account not only for the wine purchase but also for the cost of shipping and any applicable taxes and/or fees. The third party maintaining the website may or may not have a direct agreement with a shipper for low-cost shipping fees which are passed on to the consumer. If the retailer receives the consumer's payment for shipping costs, then the retailer then pays the shipper. The retailer may also directly pay the wholesaler that supplied the purchased wine to the retailer. In an alternative embodiment, the order management system of the present invention may facilitate payment to the shipper and/or wholesaler on behalf of the retailer. For example, the method of the present invention may include the steps of transferring the cost of shipping from the retailer's merchant account to an account for conducting financial transactions over a payment network associated with the shipper, and/or transferring the wholesale cost of the wine from the retailer's merchant account to an account for conducting financial transactions over a payment network associated with the wholesaler.

In one embodiment, the retailer may have a commitment to purchase a certain amount of wine product. If so, then once a transaction selling that wine is completed, the order management system will transfer funds to the wholesaler/warehouse in accordance with relevant invoicing. The retailer then assumes ownership over the wine being purchased. It should be noted that the retailer might take control or ownership of the wine being purchased at a different stage in the process. In one embodiment, this occurs via a cross-dock transfer, such that the wine is transferred within a single warehouse or space from the wholesaler's ownership/space to the retailer's ownership/space. In this instance, it might be the same public warehouse employees handling the wine and making the order available for pick up. Alternatively, the retailer and wholesaler may store the wine product in different locations.

The retailer may send a purchase order to the wholesaler for the wine product, and/or the wholesaler may send an invoice to the retailer. In one embodiment, the method of the present invention further comprises managing this process for the wholesaler and retailer. For example, as part of the method of the present invention, a purchase order may be sent to the wholesaler on behalf of the retailer, and/or the wholesaler may send an invoice to the producer.

Once the transaction is complete, the retailer then initiates shipment of the wine via the shipper. For example, the shipper may pick up the wine from the retailer's warehouse space. The consumer then receives the wine at the specified shipping address via the shipper.

The order management system of the present invention further relates to facilitating a charitable donation as part of the order. For example, the producer or retailer may agree to donate all or part of the proceeds of the cost of the wine to a charity. If an indication is received that all or part of the cost of the wine is a donation, then the method of the present invention may include the steps of determining the donation amount, and transferring the donation amount from the producer or retailer's merchant account to an account for conducting financial transactions over a payment network associated with the charitable organization. For example, if the producer agrees to donate 10% of certain purchases to a charity such as St. Jude's Children's Hospital, then after payment is executed, 10% of the qualifying purchase will be transferred to St. Jude's account on behalf of the producer. The method of the present invention may include the step of displaying the amount donated by the producer or retailer to the consumer. The website may display the amount of money donated to the charity by the producer or retailer for that particular transaction or in total from all transactions.

If no capable or compliant retailers are identified that can complete the desired transaction, then the present invention may suggest other producers to the consumer. For example, the method of the present invention may include the steps of identifying other producers of a particular style of wine or from a particular region, and displaying such identified producers and/or wines to the consumer. The consumer may then attempt to place a new order for wine from a different producer.

The order management system of the present invention further relates to the use of virtual currency to pay for at least part of the cost of the order, such that the cost of the order is split between the virtual currency and an internationally recognized currency such as U.S. dollars. For example, the consumer may have an account with a wine club website that offers its members the chance to earn virtual reward currency in the form of a Crown for certain activities such as posting wine reviews. The virtual currency has a correlation to internationally recognized currencies such as the U.S. dollar or other virtual currencies. The correlation may be arbitrarily set or may have a verifiable cost/perceived value set by those who purchase those currencies. Under the exemplary virtual currency system, twenty-five “glasses” of wine are equivalent to a virtual “bottle,” and five “bottles” are equivalent to a “Crown.” The correlation between the exemplary rewards currency and the U.S. dollar is arbitrarily set at glasses=$0.10, bottles=$0.50, and crowns=$2.50. The glasses/bottles/crowns virtual currency is for exemplary purposes only, and it is understood that the order management methods of the present invention may be used with any virtual currency.

The amount of virtual currency earned by a particular consumer may be stored in a database. For example, the database may associate an indication of the consumer's identification, e.g., the consumer's name or user account login credentials, with an amount of virtual currency earned by the consumer as a reward for completing certain actions, such as posting a review of a wine or making a charitable donation.

In order to facilitate the use of virtual currency to pay for at least part of the cost of the order, the methods of the present invention may include the steps of determining the consumer's amount of virtual currency by querying a database, stored on one or more computers, that contains at least one data field indicating the consumer's virtual currency amount based on the consumer's identification, converting the amount of the virtual currency that can be applied to the order to U.S. dollars based on a pre-set correlation to arrive at a converted amount, and subtracting the converted amount from the cost of the order to arrive at a new cost.

The split tender aspects of the present invention provide the added benefit of allowing a producer or retailer to discretely allocate the gross margin of a transaction to effectuate a cause related marketing program or other customer acquisition program. For example, a producer may desire to maintain the advertised retail price of a bottle of wine to the public as $35, wherein the producer is willing to accept $20 for a direct transaction that results in a new customer relationship. The order management system of the present invention allows, for example, the consumer to split the cost of the wine between virtual currency correlating to $15 and $20 in U.S. currency, such that the producer receives payment of $20 for the wine, while the perceived retail value of the wine remains at $35.

In an additional embodiment, in calculating the correlated amount of the reward currencies to be used in U.S. dollars, or at some point during the transaction process, the method of the present invention includes identifying a limit on the amount of virtual currency that a consumer can use towards a particular purchase. For example, the producer of a certain wine may allow the cost of the wine to be split between virtual and recognized currency in a 10/90 percent split, but not a 25/75 percent split based on the producer's own profit margin needs or on regulations governing wholesale rates or retailer margins. The amount of virtual currency that may be applied to an order may be determined, for example, by querying one or more databases, stored on a computer, indicating the maximum amount of virtual currency that may be applied to a particular order.

As part of the present invention, the consumer may be rewarded with or earn virtual currency for transacting an order in which at least a portion of the cost of the order is a charitable donation. For example, if a consumer purchases a bottle of wine for $20 wherein the retailer or producer has agreed to donate 25% of the purchase price to a charity, then upon completion of the transaction $5 is transferred from the producer or retailer to the charity, as described above, and the consumer earns rewards in the form of virtual currency correlating to the total amount of the purchase in US dollars or some other amount.

In an additional embodiment, a retailer may wish to partner with a local charity for a cause related marketing program. The winery still wishes to maintain their $35 retail price point. The winery's wholesaler in a particular state has filed a wholesale price of $20 for retailers. In this instance the retailer would be willing to operate on a profit of $5 and donate the other $10 to the charity that has asked their supporters to participate in the fundraising promotion. The present invention can support the front-end marketing, transaction routing as well as post payment allocations for this transaction.

While the method(s) described above are with respect to Internet wine sales, the present invention is not limited to the described embodiments and is applicable to the purchase of any similarly regulated product or service over the internet such as other alcoholic beverages, e.g., fruit based alcoholic beverages, beer, cider, or ale, and online gambling.

While certain embodiments have been described, these embodiments have been presented by way of example only, and are not intended to limit the scope of the invention(s). Indeed, the novel embodiments described herein may be embodied in a variety of other forms; furthermore, various omissions, substitutions and changes in the form of the embodiments described herein may be made without departing from the spirit of the inventions. Moreover, unless otherwise indicated, singular elements may be in the plural and vice versa.

1. A non-transitory machine-readable medium comprising a plurality of machine-readable instructions to perform a computer-implemented method for managing an order for the purchase of wine between a consumer and producer over the Internet via a third party website, comprising: receiving an order from a consumer for the purchase of at least one bottle of wine, the order comprising at least one data field indicating the producer of the wine; receiving a shipping address associated with the order, the shipping address comprising at least one data field indicating a U.S. state; determining that the order qualifies for direct shipment by the producer; determining the cost of the order; identifying the producer's merchant account for conducting financial transactions over a payment network; establishing a financial transaction between the producer and the consumer for the cost of the order; initiating a payment process directed to the transaction; completing the transaction, wherein the producer's merchant account receives payment for the cost of the order; and providing a display indicating completion of the transaction.

2. The method of claim 1, further comprising displaying information to a consumer regarding wine available for purchase.

3. The method of claim 1, wherein the order further comprises a data field indicating the consumer's identification, and the shipping address is received by querying a database, stored on one or more computer servers, associating the consumer's identification with the shipping address.

4. The method of claim 1, wherein determining that the order qualifies for direct shipment by the producer comprises the steps of: determining that the indicated U.S. state is a state that allows direct shipment; and determining that the producer is direct ship compliant in the indicated U.S. state.

5. The method of claim 4, wherein it is determined that the indicated U.S. state is a direct shipment state by querying a database, stored on one or more computer servers, that contains at least one data field indicating that the indicated U.S. state is a direct shipment state.

6. The method of claim 4, wherein the producer is determined to be direct ship compliant by querying a database, stored on one or more computer servers, that contains at least one data field indicating that the producer is direct ship compliant in the indicated U.S. state.

7. The method of claim 1, wherein the cost of the order includes the cost of the wine, the cost of shipping, and any applicable taxes or fees associated with the order.

8. The method of claim 1, further comprising determining that at least a portion of the cost of the order is a donation by the producer to a charitable organization; and transferring the donation amount from the producer's merchant account to an account for conducting financial transactions over a payment network associated with the charitable organization.

9. The method of claim 8, wherein the consumer is awarded virtual currency for the completed transaction.

10. The method of claim 1, further comprising: receiving, as part of the order, at least one data field indicating the consumer's identification; determining the consumer's amount of virtual currency by querying a database, stored on one or more computers, that contains at least one data field indicating the consumer's virtual currency amount based on the consumer's identification; identifying the amount of virtual currency that can be applied to the cost of the order, said amount being the applied virtual currency; calculating the equivalent amount of the applied virtual currency in U.S. dollars; subtracting the equivalent amount from the cost of the order to arrive at a new cost of the order, wherein the transaction between the producer and the consumer is completed at the new cost of the order.

11. A non-transitory machine-readable medium comprising a plurality of machine-readable instructions to perform a computer-implemented method for managing an order for the purchase of wine between a consumer and retailer via a third party website, comprising: receiving an order from a consumer for the purchase of at least one bottle of wine, the order comprising at least one data field indicating the producer of the wine; receiving a shipping address associated with the order, the shipping address comprising at least one data field indicating a U.S. state; determining that the order does not qualify for direct shipment from the producer; identifying one or more retailers that can complete the order; selecting a retailer to complete the order; determining the cost of the order; identifying the retailer's merchant account for conducting financial transactions over a payment network; establishing a financial transaction between the retailer and the consumer for the cost of the order; initiating a payment process directed to the transaction; completing the transaction, wherein the retailer's merchant account receives payment for the cost of the order; and providing a display indicating completion of the transaction.

12. The method of claim 11, wherein the order further comprises a data field indicating the consumer's identification, and the shipping address is received by querying a database, stored on one or more computer servers, associating the consumer's name with the shipping address.

13. The method of claim 11, wherein determining that the order does not qualify for direct shipment by the producer comprises querying a database, stored on one or more computer servers, that contains at least one data field indicating that the indicated U.S. state is not a direct shipment state.

14. The method of claim 11, wherein determining that the order does not qualify for direct shipment by the producer comprises querying a database, stored on one or more computer servers, that contains at least one data field indicating that the producer is not direct ship compliant in the indicated U.S. state.

15. The method of claim 11, wherein the cost of the order includes the cost of the wine, the cost of shipping, and any applicable taxes or fees associated with the order.

16. The method of claim 11, further comprising determining that at least a portion of the cost of the order is a donation by the retailer to a charitable organization; and transferring the donation amount from the retailer's merchant account to an account for conducting financial transactions over a payment network associated with the charitable organization.

17. The method of claim 16, wherein the consumer is awarded virtual currency for the completed transaction.

18. The method of claim 11, wherein it is determined that only one retailer can complete the order.

19. The method of claim 11, wherein it is determined that more than one retailer can complete the order, further comprising: receiving a price for the cost of the order from at least one of the retailers, and selecting the retailer with the lowest price for completing the transaction.

20. The method of claim 11, further comprising transmitting a purchase order for the wine from the retailer to a wholesaler of the wine.

21. The method of claim 11, further comprising transmitting an invoice for the wine from the wholesaler of the wine to the retailer.

22. The method of claim 11, further comprising: receiving, as part of the order, at least one data field indicating the consumer's identification; determining the consumer's amount of virtual currency by querying a database, stored on one or more computers, that contains at least one data field indicating the consumer's virtual currency amount based on the consumer's identification; identifying the amount of virtual currency that can be applied to the cost of the order, said amount being the applied virtual currency; calculating the equivalent amount of the applied virtual currency in U.S. dollars; subtracting the equivalent amount from the cost of the order to arrive at a new cost of the order, wherein the transaction between the retailer and the consumer is completed at the new cost of the order.

23. A non-transitory machine-readable medium comprising a plurality of machine-readable instructions to perform a computer-implemented method for managing an order for the purchase of wine between a consumer and retailer or producer via a third party website, comprising: receiving an order from a consumer for the purchase of at least one bottle of wine, the order comprising at least one data field indicating the producer of the wine; receiving a shipping address associated with the order for receiving shipment of the order, the shipping address comprising at least one data field indicating a U.S. state; determining that the order cannot be completed; identifying other producers that produce similar wines to recommend to the consumer; displaying the recommended wines to the consumer.
